(19) United States
(12) Patent Application Publication
(10) Pub. No.: US 2010/0032069 A1
(43) Pub. Date: Feb. 11, 2010

(54) PUNCTURE-PROOF TYRE

(76) Inventor: Ralf Müller, Viersen (DE)

Correspondence Address: SCHWEGMAN, LUNDBERG & WOESSNER, P.A., P.O. BOX 2938, MINNEAPOLIS, MN, 55402, US

(21) Appl. No.: 12/083,568

(22) PCT Filed: Oct. 17, 2006
(86) PCT No.: PCT/EP2006/010005

§ 371 Date: Oct. 8, 2009

(30) Foreign Application Priority Data
Oct. 17, 2005 (DE) 10 2005 049 526.5

(51) Int. Cl. B60C 19/12; B29D 30/00

(52) U.S. Cl. 152/503; 152/510; 156/110.1

(57) ABSTRACT

The present invention relates to a puncture-proof tyre assembly in which a sealant of a rubber or another rubber-like material is pressed against the tread of the tyre assembly such that there is a higher pressure in this sealant chamber than in the air chamber, and the sealant comprising at least one filler, as well as to a method for producing this tyre assembly and to the use of aqueous gels in producing these puncture-proof tyre assemblies.

The invention relates to a puncture-proof tyre assembly for vehicles, for example for automobiles, motor cycles, cycles, perambulators, wheelchairs, handcarts and the like. In particular, the invention relates to a tube for vehicle tyres. The principle can, however, also be applied to tubeless vehicle tyres or to motor vehicle tyres.

By way of example, it is known in principle with regard to putting tyres on wheelchairs to make use of tyres made from a solid material. However, such a tyre is relatively heavy, is poor in cushioning shocks and is also relatively expensive. One alternative is pneumatic tyre assemblies. However, these are more prone to punctures and they have to be regularly pumped up.

Since the use of pneumatic tyre assemblies for example tubeless pneumatic tyres and tyre assemblies composed of pneumatic tubes and casings holding them, attempts have been made to avoid defects of the air chambers of these pneumatic tyre assemblies and/or to remove existing defects, in order to enable the further use of the pneumatic tyre assembly without a complicated change of the pneumatic tyre or tube.

There are the following possibilities in the prior art for reducing the risk or avoiding a tyre defect:

Products from Ralf Bohle GmbH, Reichsdorf teach fashioning a thicker cycle tyre (up to approximately 1 cm). This can certainly avoid most tyre punctures, but relatively long foreign bodies can penetrate the casing. Moreover, these tyres have a greater rolling resistance than simple tyres and are relatively expensive.

The products from Michelin, Clermont-Ferrand, France teach fashioning a thicker cycle tyre (up to 5 mm), however, this can also be penetrated by relatively long foreign bodies.

Also similarly fashioned is the air tube disclosed in DE 118736, which was bonded in the expanded state to a rubber strip such that the latter experiences a strong compression in the nonexpanded state. If the tread is damaged by penetration of a sharp object, the relevant opening can immediately close again automatically. However, even this succeeds only when the penetrating object does not produce excessively large holes.

Product developments of Ralf Bohle GmbH, Michelin and Continental AG, Hanover, teach reinforcing the cycle tyres with a tear-proof fabric (for example Kevlar). However, sharp and angular foreign bodies can sever this in some circumstances.

In the case of a tyre of Chariots All Terrain Pushchairs, Spreyton, UK, an insert made from plastic is inserted between the tube and the casing. However, even this can be penetrated and, furthermore, reduces the elasticity to shocks and increases the rolling resistance.

Products from Aerotube Technology LLC, Cornville, USA teach using a tube with a filling made from foam or the like. However, in the course of time stability of these tubes falls off, their rolling resistance is higher, they cannot efficiently cushion shocks, and they cannot be reused in the event of a change of tyre.

DE 437673 teaches the use of a dual chamber air tube whose chamber which is to lie behind the running casing is filled with sponge rubber to prevent damage to the tube, the sponge rubber being connected to one of the chamber walls and being impregnated with sealing liquid. However, the ability to patch relatively large holes is diminished in the case of this tube.

DE 94142 describes a self-sealing air tyre in the case of which a layer of unvulcanized rubber is accommodated in a hermetically closed pocket or chamber with the aim of preventing oxidation and hardening of the unvulcanized rubber, and in order to ensure its position at the required site. However, this unvulcanized rubber has the disadvantage that it hardens with time and is therefore no longer able to have a sealing effect in the case of a tyre defect. Similar self-sealing air tyres or tubes in the case of which a sealant is located in a pocket are described in US 2003/0205308, in U.S. Pat. No. 1,689,907 and in EP 1 201 431. In the case of damage caused to the air tyre by a large object, the sealant can, however, not entirely seal the hole and instead runs out of the pocket.

It is also known to fill gel into the tube. This gel is put into the tube through the valve as a precaution or after the occurrence of a defect. Together with the exiting air, said gel forms a plug in the case of a defect, which seals the hole. It is possible thus to stop the hole by small threads, for example. However, it is still possible for air to exit. It is therefore also necessary to carry along an air pump. Moreover, it is impossible to patch relatively large holes. Depending on field of use, such gels are able to patch only holes in the tyre assembly with an object diameter of at most 3 mm (cycle tyres) or at most 10 mm (car tyres) since, depending on specification, the sealing gels available commercially are formulated with a different viscosity and with different proportions of further components (compare data for the Profex sealing gel from Stinnes-Intertec, and for the Dr. Loc tyre sealing gel from TERRA-S Automotive Systems GmbH & Co. KG, Owingen). These different viscosities and proportions of further components are caused by the desired flow behaviour in the tyre to be patched, which depends on the diameter of the tyre and on the typical riding/driving speed. Moreover, the valve can also stick owing to the filling with the sealing gel. Honda has formulated a number of patent applications (for example JP-08-22502, EP 1 201 461 and DE 699 03 876) in order to avoid the latter.

It follows from this that a multilayer configuration and the use of gels are known. In the case of Honda's patent applications, the rubber which is between the air chamber and the sealant chamber, causes the air chamber to contract. Consequently, the air is lower in the sealant chamber than in the air chamber. Upon penetration of this rubber, air penetrates from the air chamber into the sealant chamber, and gel can also move through the hole. The rubber relaxes until it is rectilinear. No further punctureproofness is ensured.

It is therefore an object of the invention to provide a puncture proof tyre assembly which is also punctureproof in the event of the penetration of long, relatively large and sharp foreign bodies, and which is therefore capable of patching even relatively large holes in the tyre assembly. In particular, the aim is for no air to exit from the punctureproof tyre assembly. Furthermore, it appears to be unnecessary for an air pump to be carried along. Finally, the aim is to provide an appropriate puncture-proof tyre assembly which fulfils the usual requirements of tyre assemblies. In particular, it is aimed for this to have an appropriate rolling resistance and a suitable elasticity to shocks. Furthermore, corresponding tyre assemblies are intended to permit use of simple, favourably priced casing when use is made of a tube.

This object is achieved by a punctureproof tyre assembly, that is to say a punctureproof tube together with a casing, or by a punctureproof tubeless tyre in which a sealant of a rubber or another rubber-like material is pressed against the tread of the tube or the tyre such that there is a higher pressure in this chamber than in the air chamber. The expanded rubber or the expanded rubber-like material tends to contract towards the sealant chamber, that is to say the rubber or the rubber-like material acts to compress the contents of the sealant chamber.

The sealant of the punctureproof tyre assembly is preferably located in at least one sealant chamber which is closed off from the air chamber and is formed from the inner side of the tread of the tyre assembly and from the rubber or the rubber-like material.

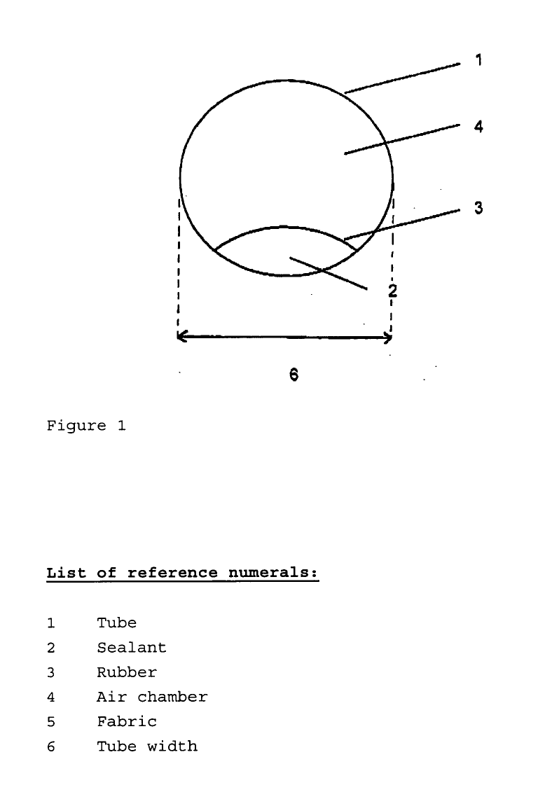

The punctureproof tyre assembly is illustrated diagram-matically in FIG. 1 on the example of a punctureproof tube. The tube 1 and the rubber 3 form a sealant chamber in the region of the inner side of the tread. The rubber 3 is curved outward towards the air chamber 4 when seen from the sealant chamber, and is expanded such that it tends to contract towards the sealant chamber and thereby effects a pressure rise in the sealant chamber. The pressure is higher in this sealant chamber than in the air chamber 4. The sealant chamber, that is to say the rubber 3 and/or the inner side of the tread of the tube which delimits the sealant chamber, can consist of materials with another E module than the remainder of the tube, in order, optionally, to save weight and in order to keep the expansion in the region of a puncture site as small as possible. This can be necessary because of the definition of the shape and the rise in pressure. In the case of coextrusion, it is possible for various materials to be extruded together. There is a sealant 2 in the sealant chamber.

The nature of the sealant is such that the latter cannot exit through holes or cracks in the tube or in the tyre that are normally possible, or that it stops them very quickly. This can be achieved, for example, by at least one added filler. Fillers are to be understood in this context as substances which are present undissolved in the sealant and have a sufficient size and a suitable shape in order, for example, to effect a mechanical closure of a defect of the tyre assembly through being tilted or interlocked with one another. In particular, the filler is to be understood as threads and/or other solid, lumpy components.

It is fundamentally possible to use normal fillers such as rubber particles, cellulose, carbonates, silicates, silica and the like, as well as mixtures thereof. In addition, or as an alternative thereto, it is possible to make use as fibrous fillers, that is to say threads, of, in particular, cellulose fibres, glass fibres, nylon fibres and/or cotton fibres as well as of sheetlike fabric pieces of said fibres.

Such fillers are preferably contained in a quantity of at least 0.1% by weight, in particular in a quantity of 0.1% by weight to 5% by weight referred to the total weight of the sealant.

The sealant preferably comprises a gel. The sealant further preferably comprises an aqueous gel. However, there are already gels which can be further optimized for this case. These gels usually contain at least one sealant, an adhesion promoter, water and furthermore, optionally, for example, anti-gelling agents, dispersants, solvents, dyes, general preservative agents such as, for example, antioxidants, and bactericides as well as catalysts. A commercial tyre sealing gel for commercial vehicles (up to 80 km/h and 3.5 bar tyre pressure) can seal holes up to an object diameter of 10 mm. By contrast with the known method with the customary tyre sealing gels for cycles (sealing up to 3 mm object diameter), it is possible here to use more relatively large and lumpier components. The tyre sealing gel used according to the invention can be more viscous, since it need not be distributed by the centrifugal force during driving. In the extreme case, the sealant flows only under pressure. It can be plastically deformed by the pressure in the sealant chamber.

The sealant can be spread into the sealant chamber during the production of the tube (see below). In this case, overpressure can be produced as early as during the production. After the mounting of the tube and of the tyre, the sealant can be nonuniformly distributed. However, it can be further distributed again by the pressure in the sealant chamber and by the centrifugal forces during driving.

If a foreign body has penetrated the tyre assembly, this causes the sealant to be pressed against the side of the foreign body again during the extraction of the foreign body, that is to say the sealant is moved, by the higher pressure in the sealant chamber by comparison with the atmosphere, through the outer puncture site in the tube or tyre wall (and, if appropriate, also to the inner puncture site in the rubber) and seals the puncture openings there, firstly by blocking with the aid of the filler and, if appropriate, subsequently by curing the sealant to the air. It is thereby impossible for air to exit from the tube. By pressing in the sealing gel to the leak, more sealing gel acts in a sealing fashion than when only some material from the surroundings of the leak is drawn towards the leak by air draught, and so larger holes can be sealed.

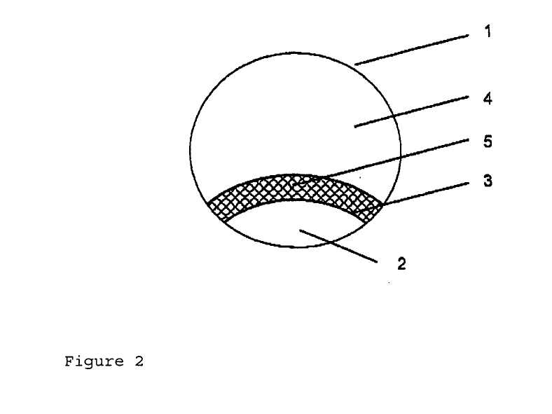

If the sealant 2 is such that it can penetrate into the air chamber 4 through a hole in the rubber 3 or in the rubber-like material, this can be prevented by a fabric 5 (compare FIG. 2). What is to be understood in this context as fabric is any material which can be penetrated only poorly by a foreign body owing to a crosslinked or woven structure, and which therefore effects a reinforcement of the rubber or of the rubber-like material. To be understood, in particular, as fabric are textile fabrics made from natural or synthetic fibres, gratings and lattices made from metal or plastic, as well as soft plastics and plastic foams with said properties. The fabric is preferably elastic. The fabric is preferably arranged on the side, orientated towards the air chamber, of the rubber or the rubber-like material. What is involved here can be, for example, an elastic, air pervious fabric (for example foam, in particular polyurethane foam). Either the foreign body cuts a small hole into the fabric 5, or pressure is exerted away from the rubber or the rubber-like material in the region of the foreign body. It is possible at most only for a small space to result which can be filled with the sealant, that is to say despite a possible penetration of a foreign body into the rubber or the rubber-like material, the sealant cannot pass into the air chamber. Enough sealant remains behind in order to stop further holes.

As a force against the pressure of the exiting liquid, the fabric can, for example, be worked directly into the rubber or the rubber-like material during the extrusion of the tube, or it is subsequently bonded onto the rubber or the rubber-like material. The counterpressure can also be produced by the fabric itself (when the air space is completely filled up), or by a further rubber. That is to say, the rubber-like material, which presses the sealant against the tread of the tyre assembly, can be identical to the fabric.

The fabric can completely or as illustrated in FIG. 2—only partially fill up the air chamber of the tube. Since the fabric can be pressed together, there is no obstacle when mounting the tube on the rim. Nor is there any appreciable resistance when pumping up the tube.

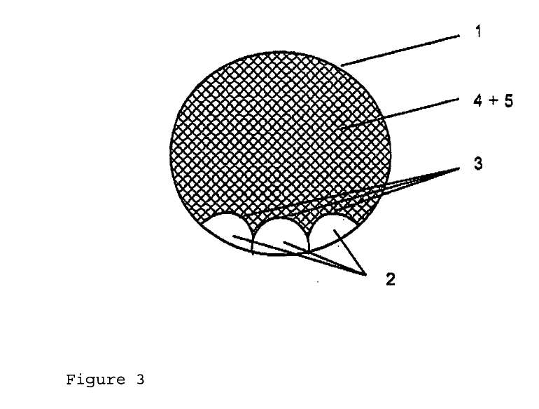

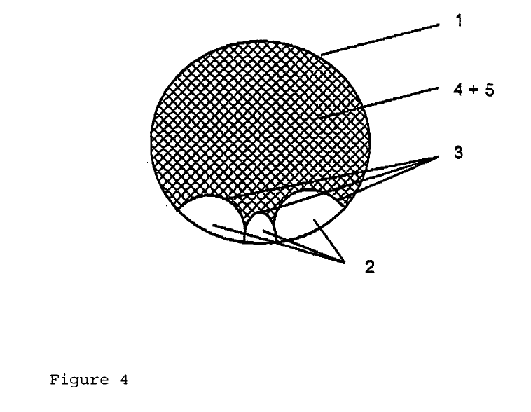

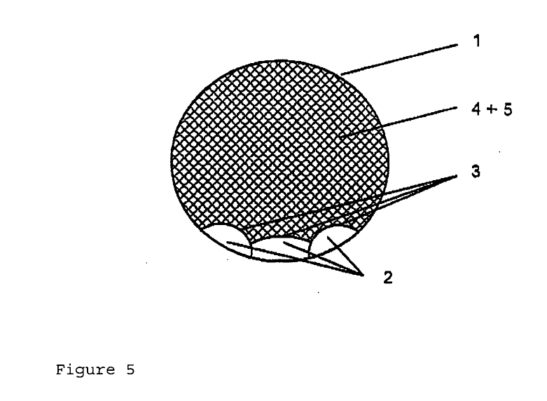

Another variant of the configuration of the inventive tyre assembly on the example of a tube is shown in FIG. 3. Here, the tube 1 has a number of relatively small chambers for sealant 2 next to one another, that is to say instead of a sealant chamber located in the region of the tread, in this embodiment a number of relatively small ones which are arranged substantially next to one another are located there. Sealant 2 is saved as a result, and the tube becomes lighter. The air previous fabric 5 can fill up the entire air chamber. There is also puncture protection in the region of the partitions between the sealant chambers. This is at its simplest when the sealant chambers are of different size, as illustrated in FIG. 4. A relatively large chamber thereby projects beyond a relatively small chamber and partially lies on it, or its walls will be oblique to the tread, that is to say, as illustrated in FIG. 5, the sealant chambers have common partitions that are not orientated in the direction of the tyre assembly midpoint. Embodiments of this inventive tyre assembly are illustrated in FIGS. 3 to 5, for example, for a tube. A shape is created in the case of which a penetrating body must penetrate into at least one sealant chamber. This particularly preferred embodiment thus ensures a further improved puncture protection because, given a suitable orientation, the penetrating body must damage more partitions before the air space of the tyre assembly is reached, and because each hole caused by it in the partitions is patched by sealant from different sealant chambers. Even in the case of a complete destruction of a sealant chamber, there is thus still sealant available for repairing the other holes, and so the probability of the air chamber remaining intact is increased. Another, but not so good possibility is that the chambers of equal size are slightly offset in height. This requires the outer rubber, that is to say the tread of the tube, to be of different thickness. It can also suffice for the partitions to be fashioned very thin. There can also be a further, small sealant chamber exactly over the parting surface.

For tyre assemblies based on a casing and a tube, it is possible to use the two variants both for groups of tubes, that is to say tubes having a defined diameter but of variable width, and for specialized tubes, that is to say tubes of defined diameter and width.

The inventive punctureproof tyre assembly offers a particularly good puncture protection for tubes and/or tyres having a width (compare FIG. 1, the tyre width 6 being illustrated) of less than 120 mm, further preferably less than 100 mm, with particular preference less than 70 mm. That is to say, the inventive tyre assembly is particularly suitable for puncture protection of motorcycles, cycles, perambulators, wheelchairs, handcarts and the like. The invention is very particularly suitable for puncture protection of cycles, perambulators, wheelchairs and handcarts.

The sealant chambers can be produced by a tool in one work operation during the extrusion of the tyre assembly, for example when extruding the cycle tube. The fabric can likewise be connected directly to the rubber or the rubber-like material during extrusion. Alternatively, it can also be subsequently bonded onto the rubber or the rubber-like material. The individual tubes are then cut to length and the valve is inserted. The fabric can subsequently be foamed into the cut-to-length pieces, or foaming is finally performed into the air chamber through the valve opening. Before the vulcanization and the connection, taking place therewith, of the two ends, it is necessary in some circumstances to attach a web to the rubber or to the rubber-like material. The individual partitions between the chambers need not (but can) be interconnected. An in any case only minimum exchange of material, that is to say of sealant, between the chambers does not impair their efficiency. Another possibility is to introduce at the connecting site a tool which fixes the individual rubber or only the rubber or the rubber-like material at the connecting site in an overlapping or abutting fashion. If only the rubber or the rubber-like material is fixed, the tool can be introduced both via the sealant chamber and via the air chamber. An overpressure is produced for the vulcanization both in the air chamber (through the valve) and in the sealant chambers. The openings required for this purpose in the sealant chambers can also be used for filling with the sealant. These openings of the sealant chambers are preferably located in the region of the tread. If use is made during vulcanization of a tool introduced via the sealant chamber, it is also possible to use these openings for the purpose. They can subsequently be sealed by cold vulcanization. Alternatively, the sealant chambers can also be filled through the air valve with the aid of a filling device.

If the pressure is so high during vulcanization that the vulcanization temperature is not above the corresponding pressure dependent boiling point of the sealant, the sealant can also be filled into the sealant chambers even before vulcanization.

In the state before being pumped up, the tube is certainly thicker owing to the additional material, that is to say the filled sealant chambers, but this is not an obstacle for mounting. One possibility is, for example, to pull one side of the casing over the rim, to leave it on the side of the rim, to plant the valve through the opening of the rim, to lay the tube into the casing, to push the casing further over the rim, and to raise the other side of the casing over the edge of the rim. The pressure in the sealant chamber(s) precludes twisting of the tube.

The present invention seals even relatively large holes in the tube without air being able to exit. It is even possible to seal a number of holes. Rolling resistance and elasticity to shocks are comparable to those of simple tubes. The tubes can be reused in some circumstances after a tyre change. The additional weight will be insignificant in practice.

This tube enables combination with a relatively favourably priced casing in conjunction with better puncture protection and optimized rolling properties.

1. Puncture-proof tyre assembly comprising a tread and walls, which tread and walls form an air chamber, and wherein a sealant of a rubber or another rubber-like material is pressed in the tyre against the tread of the tyre assembly to form a sealant chamber such that there is a higher pressure in this sealant chamber than in the air chamber.

2. Punctureproof tyre assembly according to claim 1, wherein the sealant comprises at least one filler.

3. Punctureproof tyre assembly according to claim 1 wherein the sealant flows only under pressure.

4. Punctureproof tyre assembly according to claim 1 wherein the sealant is plastically deformed by the pressure in the sealant chamber.

5. Punctureproof tyre assembly according to claim 1 claims, wherein the sealant of the punctureproof tyre assembly is contained in at least one sealant chamber which is closed off from the air chamber and is formed from the inner side of the tread of the tyre assembly and from the rubber or the rubber-like material.

6. Puncture-proof tyre assembly according to claim 1 claims, wherein fibres and/or lumpy materials are used as filler.

7. Puncture-proof tyre assembly according to claim 6, wherein fibres and lumpy materials are used as filler.

8. Puncture-proof tyre assembly according to claim 1 wherein the sealant comprises, as at least one filler, rubber particles, cellulose, carbonates, silicates, silica, cellulose fibres, glass fibres, nylon fibres, cotton fibres and/or sheetlike fabric pieces of said fibres.

9. Puncture-proof tyre assembly according to claim 1 wherein the sealant contains at least 0.1% by weight, preferably 0.1% by weight to 5% by weight, of the at least one filler with reference to the total weight of the sealant.

10. Puncture-proof tyre assembly according to claim 1 wherein the sealant comprises a gel.

11. Puncture-proof tyre assembly according to claim 10, wherein the sealant comprises an aqueous gel.

12. Puncture-proof tyre assembly according to claim 1 wherein a fabric prevents sealant from flowing out into the interior of the tyre.

13. Punctureproof tyre assembly according to claim 12, wherein the fabric is elastic.

14. Punctureproof tyre assembly according to claim 12 wherein the fabric is arranged on the side, orientated towards the air chamber, of the rubber or the rubber-like material.

15. Punctureproof tyre assembly according to claim 12 wherein fabric is a polyurethane foam.

16. Punctureproof tyre assembly according to claim 12 wherein the fabric completely fills up the air chamber.

17. Puncture-proof tyre assembly according to claim 12 wherein the fabric partially fills up the air chamber.

18. Puncture-proof tyre assembly according to wherein it has a number of relatively small sealant chambers next to one another.

19. Punctureproof tyre assembly according to claim 18, wherein the sealant chambers are of different size.

20. Punctureproof tyre assembly according to claim 19, wherein at least one relatively large chamber projects beyond at least one relatively small chamber and partially lies on it.

21. Puncture-proof tyre assembly according to claim 19, wherein the sealant chambers have common partitions that are not orientated in the direction of the tyre assembly midpoint.

22. Punctureproof tyre assembly according to claim 1 wherein the tube or tyre of the tyre assembly has a width of less than 120 mm, further preferably less than 100 mm, with particular preference less than 70 mm.

23. Method for producing a puncture-proof tyre assembly according to claim 1 wherein the sealant chambers are produced in one work operation during the extrusion of the tyre assembly.

24. Method for producing a puncture-proof tyre assembly according to claim 23, wherein a fabric is subsequently bonded onto the rubber or the rubber-like material.

25. Method for producing a puncture-proof tyre assembly according to claim 23 wherein the filling of the sealant chambers with the sealant is performed by the openings of the sealant chamber used to produce an overpressure during vulcanization.

26. Method for producing a punctureproof tyre assembly according to claim 23 wherein the filling of the sealant chambers with a sealant is performed through the air valve with the aid of a filling device.

27. Use of an aqueous gel comprising 0.1% by weight to 5% by weight of at least one filler in producing a puncture-proof tyre assembly, in the case of which as sealant the aqueous gel is contained in at least one sealant chamber, closed off from the air chamber, of the tyre assembly, and the sealant chamber being formed from the inner side of the tread of the tyre assembly and from a rubber or a rubber-like material.
